(19) United States
(12) Patent Application Publication
(10) Pub. No.: US 2025/0001884 A1
(43) Pub. Date: Jan. 2, 2025

(54) CABLE FOR SUPPLYING BACKUP POWER TO A BUILDING FROM AN ELECTRIC VEHICLE

(71) Applicant: Toyota Motor North America, Inc., Plano, TX (US)

(72) Inventors: Ronnie Nomoto, Frisco, TX (US); Norman Ning Lu, Fairview, TX (US); Geoffrey David Gaither, Ann Arbor, MI (US)

(73) Assignees: Toyota Motor North America, Inc., Plano, TX (US); Toyota Jidosha Kabushiki Kaisha, Toyota-Shi Aichi-Ken (JP)

(21) Appl. No.: 18/216,270

(22) Filed: Jun. 29, 2023

(51) Int. Cl. B60L 53/18; B60L 53/22; H02J 9/06

(52) U.S. Cl. CPC B60L 53/18; B60L 53/22; H02J 9/062

(57) ABSTRACT

Embodiments of a backup power cable that enables an electric vehicle to supply backup power to a building are presented herein. In one embodiment, a backup power cable comprises a connector that electrically connects with a power port of an electric vehicle. The backup power cable also includes a center-tapped transformer that converts 240-V single-phase alternating-current (AC) power conveyed from the electric vehicle via the connector to 240-V split-phase AC power. The 240-V split-phase AC power includes two 120-V legs. The backup power cable also includes a plug that electrically connects with a generator outlet of the building to supply the 240-V split-phase AC power to the building as backup power.

### TECHNICAL FIELD

The subject matter described herein relates in general to backup electrical power systems and, more specifically, to a cable for supplying backup power to a building from an electric vehicle.

### BACKGROUND

When the power grid fails, popular backup-power solutions include gasoline, diesel, and propane generators. Such generators are noisy, must be operated in a well-ventilated outdoor location, and, in the case of gasoline and diesel generators, depend on stored fuel that has a relatively short shelf life (e.g., 6 to 12 months). A better backup-power solution is needed.

### SUMMARY

Embodiments of a backup power cable are presented herein. In one embodiment, a backup power cable comprises a connector that electrically connects with a power port of an electric vehicle. The backup power cable also includes a center-tapped transformer that converts 240-V single-phase alternating-current (AC) power conveyed from the electric vehicle via the connector to 240-V split-phase AC power. The 240-V split-phase AC power includes two 120-V legs. The backup power cable also includes a plug that electrically connects with a generator outlet of a building to supply the 240-V split-phase AC power to the building as backup power.

Another embodiment of a backup power cable comprises a connection unit including a connector that electrically connects with a power port of an electric vehicle and an adapter outlet that, in a first configuration of the backup power cable, permits a 240-V single-phase AC electrical apparatus to be powered by the electric vehicle, when the electrical apparatus is plugged into the adapter outlet. The backup power cable also includes a first plug that, in a second configuration of the backup power cable, is electrically connected with the adapter outlet. The backup power cable also includes a center-tapped transformer that, in the second configuration of the backup power cable, converts 240-V single-phase AC power conveyed from the electric vehicle via the connector and the first plug to 240-V split-phase AC power. The 240-V split-phase AC power includes two 120-V legs. The backup power cable also includes a second plug that, in the second configuration of the backup power cable, electrically connects with a generator outlet of a building to supply the 240-V split-phase AC power to the building as backup power.

Another embodiment of a backup power cable comprises a connection unit that electrically connects with a power port of an electric vehicle. The backup power cable also includes a center-tapped transformer that converts 240-V single-phase AC power conveyed from the electric vehicle via the connector to 240-V split-phase AC power. The 240-V split-phase AC power includes two 120-V legs. The backup power cable also incudes a first plug that electrically connects with a generator outlet of a building to supply the 240-V split-phase AC power to the building as backup power.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an embodiment of a backup power cable.

FIG. 2 illustrates another embodiment of a backup power cable.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Electric vehicles, with their high-capacity batteries, are an attractive alternative source of backup power when the power grid fails because they are a clean, quiet source of energy that can be accessed in an enclosed space (e.g., a garage). Herein, the term “electric vehicle” (EV) refers to both purely electric vehicles (no internal combustion engine) and plug-in hybrid electric vehicles (vehicles equipped with both an electric motor and an internal combustion engine). In the literature and in industry, a purely electric vehicle is also sometimes referred to as a “battery electric vehicle” (BEV).

Over the past few years, vehicle manufacturers have begun producing EVs that support “bidirectional charging.” meaning the ability to charge the vehicle and to discharge power stored in the battery through the same port on the vehicle. This ability for the vehicle to discharge stored battery power makes it possible for the vehicle to serve as a source of backup electrical power during a grid-down scenario. Some vehicle manufacturers have begun producing vehicles that can output both 240-V single-phase alternating-current (AC) power and 240-V split-phase AC power, the latter being compatible with buildings that are equipped with a generator outlet, a manual transfer switch, and a sub-panel that routes backup power via two 120-V legs to the building's electrical circuits. Such an arrangement permits the EV to power an entire residence or place of business—at least for a limited period (e.g., a few hours). Such a turnkey backup-power solution adds to the cost of the vehicle, however, and not all EVs currently being manufactured include this capability. For example, many EVs that support bidirectional charging output only 240-V single-phase AC power, which is not compatible with the majority of devices and appliances in a typical residence or place of business. Such devices and appliances (e.g., TV sets, computers, dishwashers, etc.) require a 120-V power supply.

Various embodiments of a backup power cable described herein address the as-yet-unmet need in the art for a simple, cost-effective way for an EV to serve as a source of backup power for a building when the power grid is down. In these embodiments, the backup power cable enables an EV that outputs 240-V single-phase AC power to be connected to a generator plug of a building to supply backup power to the entire building (i.e., to some or all electrical circuits in the building and any connected devices and appliances that operate from an 120-V power supply). In one embodiment, the backup power cable includes a connector that connects with a power port of the EV, an integrated center-tapped transformer that converts the EV's 240-V single-phase AC power to 240-V split-phase AC power, and a plug that plugs into a building's generator outlet. Those skilled in the art will recognize that the EV, to output 240-V single-phase AC power, includes an inverter or equivalent device to convert DC power from the battery to AC power. Those skilled in the art will also recognize that the 240-V split-phase AC power output by the integrated transformer includes two 120-V legs for compatibility with devices and appliances that require a 120-V power supply (the vast majority of devices and appliances in most buildings).

In another embodiment, the backup power cable has a connection unit that includes a connector that connects with the power port of the EV and additionally includes an adapter outlet. In this embodiment, the backup power cable can be configured in two different ways, depending on the end user's application. In a first configuration, a 240-V single-phase AC electrical apparatus (e.g., an arc welder or clothes dryer) is plugged into the adapter outlet of the connection unit and powered by the EV. In a second configuration, a second portion of the backup power cable is added to the connection unit (the first portion). That is, a plug is plugged into the adapter outlet to add, in series, the center-tapped transformer described above and another plug that plugs into the building's generator outlet. In this second configuration, the backup power cable operates as described above to enable the EV to supply backup power to an entire building.

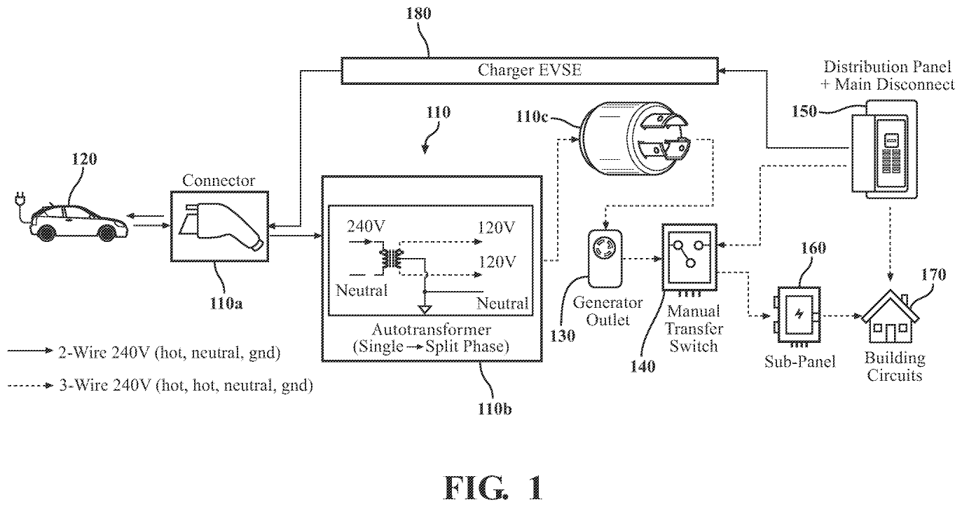

Referring to FIG. 1, it illustrates an embodiment of a backup power cable. In the description of this embodiment, the backup power cable, as a whole, is referred to as backup power cable 110. As shown in FIG. 1, backup power cable 110 includes a connector 110a that electrically connects with the power port (not shown in FIG. 1) of an EV 120. In some embodiments, the connector 110a is a Society of Automotive Engineers (SAE) J1772 connector. In other embodiments, the connector 110a is a North American Charging Standard (NACS) connector (used by Tesla, Inc.) or some other type of connector. Herein, the “power port” of an EV refers to the electrical terminal through which the vehicle is charged and through which the vehicle can discharge 240-V single-phase AC power (bidirectional charging, as discussed above). When the EV is being charged, the power port functions as a power inlet. When the vehicle is discharging power (e.g., to provide backup power to a building), the power port functions as a power outlet.

As discussed above, backup power cable 110 also includes an in-line center-tapped transformer. In the particular embodiment shown in the FIG. 1, a center-tapped autotransformer 110b (hereinafter often referred to as “autotransformer 110b”) is used. In other embodiments, a different kind of center-tapped transformer, such as a center-tapped isolation transformer, can be used. Autotransformer 110b receives 240-V single-phase AC power from the EV 120 via connector 110a and outputs 240-V split-phase AC power in two 120-V legs. That is, at the output of the autotransformer 110b, the electrical potential (voltage) between the neutral wire and either of two hot wires (see FIG. 1) is 120 V.

As shown in FIG. 1, backup power cable 110 also includes a plug 110c that can be plugged into (electrically connected with) a building's generator outlet 130. Generator outlet 130 can be any of a variety of different types. In one embodiment, generator outlet 130 is a National Electrical Manufacturers Association (NEMA) L14-30R outlet. In that embodiment, plug 110c is a compatible NEMA L14-30 P plug. Herein, “building” refers to any enclosure that accepts 240-V split-phase AC power. Examples include, without limitation, a residence (home, apartment, townhouse, condominium, etc.) and a building that serves as a place of business.

As shown in FIG. 1, backup power cable 110 is used in a setting in which a building is equipped with the generator outlet 130 just mentioned, a transfer switch 140, and a sub-panel 160. The transfer switch 140 (a manual transfer switch, in this embodiment) enables an end user (e.g., a homeowner) to select between (1) the distribution panel 150 associated with the commercial power grid and (2) sub-panel 160. When selected, sub-panel 160 routes the 240-V split-phase AC power output by autotransformer 110b (the backup power from EV 120) to one or more building circuits 170 to power devices, appliances, etc.

Though not directly related to backup power cable 110, FIG. 1 also shows charger Electric Vehicle Supply Equipment (EVSE) 180. When the power grid is functioning normally and the end user has, via transfer switch 140, selected power from distribution panel 150 (the commercial power grid), a charging cable distinct from the backup power cable 110 described herein can be connected to the power port of EV 120 and to a 240-V single-phase AC power source in distribution panel 150 to charge the battery of the EV 120.

As those skilled in the art will recognize, backup power cable 110 also includes suitable conductors (e.g., copper wire rated for 30 amperes of current) to electrically connect the connector 110a, autotransformer 110b, and plug 110c in series.

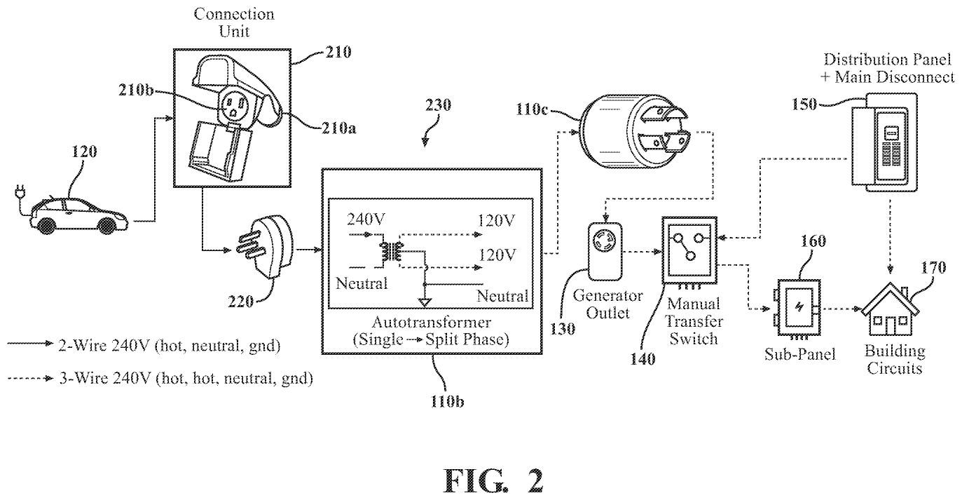

FIG. 2 illustrates another embodiment of a backup power cable. In the description of this embodiment, the backup power cable, as a whole, is referred to as backup power cable 230. This embodiment is similar to the embodiment described above, except that the backup power cable 230 has two portions that can be disconnected from or connected with each other, depending on the application the end user has in mind. The first portion includes a connection unit 210. The second portion includes a plug 220, an autotransformer 110b, and a plug 110c. As discussed above in connection with the embodiment of FIG. 1, in some embodiments a different kind of center-tapped transformer can be used. For example, a center-tapped isolation transformer can be used instead of center-tapped autotransformer 110b. In the embodiment of FIG. 2, connection unit 210 includes both (1) a connector 210a (e.g., SAE J1772 or NACS) that connects with the power port of an EV 120 and (2) an adapter outlet 210b. The adapter outlet 210b is the most important addition compared with the first embodiment (backup power cable 110) described above.

In a first configuration of backup power cable 230, the two portions of backup power cable 230 are disconnected from each other, and connection unit 210 (the first portion) is electrically connected with the power port of an EV 120. This permits a 240-V single-phase electrical apparatus such as an arc welder or a clothes dryer to be powered by plugging the electrical apparatus into the adapter outlet 210b. As illustrated in FIG. 2, in this embodiment the adapter outlet 210b is on the back side of connection unit 210 directly opposite the connector 210a. Any of a variety of outlets for a 240-V circuit can be selected for adapter outlet 210b. In one embodiment, adapter outlet 210b is a NEMA 6-50R outlet. In that embodiment, the electrical apparatus has a power cord with a compatible NEMA 6-50 P plug.

In a second configuration of the backup power cable 230, the two portions described above are electrically (and physically) connected with each other, and the connector 210a is connected with the power port of an EV 120. That is, plug 220 is plugged into the adapter outlet 210b to form a single backup power cable 230 that functions in the same manner as the first embodiment described above (backup power cable 110): to convey backup power to a building from an EV 120. In some embodiments, the plug 220 is a NEMA 6-50 P plug. In general, plug 220 is a plug for a 240-V circuit that is compatible with adapter outlet 210b (e.g., they are, respectively, a complementary male and female pair).

As in the first embodiment described above (backup power cable 110), the second portion of backup power cable 230 also includes suitable conductors (e.g., copper wire rated for 30 amperes of current) to electrically connect, in series, plug 220, autotransformer 110b, and plug 110c.

In the claims below, the terms “first” and “second.” as applied to plugs such as plugs 110c and 220, are arbitrary and are used differently, depending on which particular embodiment is being claimed.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-2, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A backup power cable, comprising:
a connector that electrically connects with a power port of an electric vehicle;
a center-tapped transformer that converts 240-V single-phase alternating-current (AC) power conveyed from the electric vehicle via the connector to 240-V split-phase AC power, the 240-V split-phase AC power including two 120-V legs; and
a plug that electrically connects with a generator outlet of a building to supply the 240-V split-phase AC power to the building as backup power.

2. The backup power cable of claim 1, wherein the building is one of a residence and a place of business.

3. The backup power cable of claim 1, wherein the building includes a transfer switch that is electrically connected with the generator outlet, the transfer switch selecting between (1) a main distribution panel that is electrically connected with a power grid and (2) a sub-panel that routes the 240-V split-phase AC power to one or more electrical circuits in the building.

4. The backup power cable of claim 1, wherein the connector is one of a Society of Automotive Engineers (SAE) J1772 connector and a North American Charging Standard (NACS) connector.

5. The backup power cable of claim 1, wherein the center-tapped transformer is one of a center-tapped autotransformer and a center-tapped isolation transformer.

6. The backup power cable of claim 1, wherein the plug is a National Electrical Manufacturers Association (NEMA) L14-30P plug.

7. The backup power cable of claim 1, wherein the generator outlet is a National Electrical Manufacturers Association (NEMA) L14-30R outlet.

8. A backup power cable, comprising:
a connection unit including a connector that electrically connects with a power port of an electric vehicle and an adapter outlet that, in a first configuration of the backup power cable, permits a 240-V single-phase alternating-current (AC) electrical apparatus to be powered by the electric vehicle, when the electrical apparatus is plugged into the adapter outlet;
a first plug that, in a second configuration of the backup power cable, is electrically connected with the adapter outlet;
a center-tapped transformer that, in the second configuration of the backup power cable, converts 240-V single-phase AC power conveyed from the electric vehicle via the connector and the first plug to 240-V split-phase AC power, the 240-V split-phase AC power including two 120-V legs; and
a second plug that, in the second configuration of the backup power cable, electrically connects with a generator outlet of a building to supply the 240-V split-phase AC power to the building as backup power.

9. The backup power cable of claim 8, wherein the building is one of a residence and a place of business.

10. The backup power cable of claim 8, wherein the building includes a transfer switch that is electrically connected with the generator outlet, the transfer switch selecting between (1) a main distribution panel that is electrically connected with a power grid and (2) a sub-panel that routes the 240-V split-phase AC power to one or more electrical circuits in the building.

11. The backup power cable of claim 8, wherein the connector is one of a Society of Automotive Engineers (SAE) J1772 connector and a North American Charging Standard (NACS) connector.

12. The backup power cable of claim 8, wherein the center-tapped transformer is one of a center-tapped autotransformer and a center-tapped isolation transformer.

13. The backup power cable of claim 8, wherein the adapter outlet is a National Electrical Manufacturers Association (NEMA) 6-50R outlet.

14. The backup power cable of claim 8, wherein the first plug is a National Electrical Manufacturers Association (NEMA) 6-50P plug.

15. The backup power cable of claim 8, wherein the second plug is a National Electrical Manufacturers Association (NEMA) L14-30P plug.

16. The backup power cable of claim 8, wherein the generator outlet is a National Electrical Manufacturers Association (NEMA) L14-30R outlet.

17. A backup power cable, comprising:
a connection unit that electrically connects with a power port of an electric vehicle;
a center-tapped transformer that converts 240-V single-phase alternating-current (AC) power conveyed from the electric vehicle via the connector to 240-V split-phase AC power, the 240-V split-phase AC power including two 120-V legs; and
a first plug that electrically connects with a generator outlet of a building to supply the 240-V split-phase AC power to the building as backup power.

18. The backup power cable of claim 17, wherein the connection unit includes an adapter outlet that, in a first configuration of the backup power cable, permits a 240-V single-phase alternating-current (AC) electrical apparatus to be powered by the electric vehicle, when the electrical apparatus is plugged into the adapter outlet, and the backup power cable further comprises a second plug that, in a second configuration of the backup power cable, is electrically connected with the adapter outlet so that the backup power is supplied to the building via the center-tapped transformer and the first plug.

19. The backup power cable of claim 17, wherein the building is one of a residence and a place of business.

20. The backup power cable of claim 17, wherein the building includes a transfer switch that is electrically connected with the generator outlet, the transfer switch selecting between (1) a main distribution panel that is electrically connected with a power grid and (2) a sub-panel that routes the 240-V split-phase AC power to one or more electrical circuits in the building.
